(19) United States
(12) Patent Application Publication
(10) Pub. No.: US 2014/0223875 A1
(43) Pub. Date: Aug. 14, 2014

(54) Self-Propelled Cutting Machine

(71) Applicants: Christian Clifford, Suffolk (GB); Richard Comely, Suffolk (GB); Adrian Kendall, Suffolk (GB); Tim Lansdell, Suffolk (GB)

(72) Inventors: Christian Clifford, Suffolk (GB); Richard Comely, Suffolk (GB); Adrian Kendall, Suffolk (GB); Tim Lansdell, Suffolk (GB)

(73) Assignee: RANSOMES JACOBSEN LIMITED, Suffolk (GB)

(21) Appl. No.: 14/342,577

(22) PCT Filed: Sep. 5, 2012
(86) PCT No.: PCT/GB2012/052178

§ 371 Date: Mar. 28, 2014

(30) Foreign Application Priority Data
Sep. 5, 2011 (GB) 1115333.5

(51) Int. Cl. A01D 34/43; A01D 34/44

(52) U.S. Cl. CPC A01D 34/435; A01D 34/44
USPC 56/14.7

(57) ABSTRACT

A self-propelled cutting machine has one cutting unit positioned in front of each forward wheel and one cutting unit positioned behind the common transverse axis of the forward wheels so that the three cutting units cut a single swathe. Each cutting unit has a cutting element with a driven shaft and a plurality of flail elements spaced along the length of the driven shaft and each rotatable with respect to the drive shaft axis about a flail element axis that is parallel to and spaced from said axis. The flail cutting element in each cutting unit can be replaced by a helical cutting reel.

### CROSS-REFERENCE TO RELATED APPLICATIONS

The present invention is the US national stage under 35 U.S.C. §371 of International Application No. PCT/GB2012/052178, which was filed on Sep. 5, 2012 and which claims the priority of application GB 1115333.5 filed on Sep. 5, 2011 the content of which (text, drawings and claims) are incorporated here by reference in its entirety.

### FIELD

This invention relates to the cutting of grass or similar vegetation and in a particular example is concerned with self-propelled cutting machines.

### BACKGROUND

There are a wide variety of grass cutting machines designed for different applications; types of vegetation and conditions. For higher quality applications such as golf courses and some other sporting or recreational areas, the commonest cutting element is a cylinder having a helical blade, referred to as a reel, which cuts the grass by rotating past a horizontal cutter-bar, thus producing a continuous ‘scissor’ action. This is best suited to relatively fine grass, which is maintained short and upright. Long or tangled grass tends to be rolled flat rather than cut. A key advantage of this type of cutting element is that grass can be cut to a high degree of accuracy (i.e. to a controllable and uniform height). Large swathes of grass can be cut by having a number of reels attached to the same machine. It is common for these types of cutters to be mounted onto specially designed machines in a variety of different arrangements. One arrangement has three cutting units; one disposed in front of each front wheel of the machine and the other supported centrally beneath the machine. This arrangement enables a characteristic striped appearance to be created, if desired.

In agricultural or other coarse cutting applications, it is common to use a type of grass cutting unit called a ‘flail’. This consists of a number of flail elements which are rotated at high speed. The high inertia of the flail elements makes this type of cutter suitable to cut tall or coarse grass, or thick vegetation. It is common for these cutters to be mounted on or towed by a tractor. Generally, where flail cutting elements are used to cut grass, grassland management factors are key rather than any aesthetic criteria. For example, flail cutters can be used in paddocks to control fast growing and coarse plant species, thereby to promote the growth of more nutritious grass.

### SUMMARY

According to the present invention there is provided a self-propelled cutting machine comprising a chassis; two spaced forward ground engaging means having a common transverse axis; at least one rearward ground engaging means; a propulsion unit acting through either or both of the forward and rearward ground engaging means to propel the cutting machine over ground; and at least three cutting units, each cutting unit comprising a support and a cutting element drivably rotatable within the support about a cutting element axis that is horizontal in cutting use, there being one cutting unit positioned in use in front of each forward ground engaging means and one cutting unit positioned in use behind the common transverse axis of the forward ground engaging means so that the three cutting units cut a single swathe; wherein each cutting element comprises a driven shaft extending along the cutting element axis and a plurality of flail elements spaced along the length of the driven shaft and each rotatable with respect to the cutting element axis about a flail element axis that is parallel to and spaced from the axis.

In various embodiments, each cutting unit positioned in use in front of each forward ground engaging means is mounted on the chassis so as to be liftable into a transport position in which the cutting element axis is closer to vertical than horizontal.

In another aspect there is provided an adaptable self-propelled cutting machine comprising a chassis; two spaced forward ground engaging means; at least one rearward ground engaging means; a propulsion unit acting through either or both of the forward and rearward ground engaging means to propel the cutting machine over ground; and at least three cutting unit stations, there being at each cutting unit station a cutting unit comprising a support and a cutting element drivably rotatable within the support about a cutting element axis that is horizontal in cutting use, there being one cutting unit station positioned in use in front of each forward ground engaging means and one cutting unit station positioned so that the three cutting units cut a single swathe; wherein each cutting unit station is provided with at least two different cutting elements which are mountable in the support of the cutting unit, wherein the at least two different cutting elements comprises a flail cutting element comprising a driven shaft extending along the cutting element axis and a plurality of flail elements spaced along the length of the driven shaft and each rotatable with respect to the cutting element axis about a flail element axis that is parallel to and spaced from the axis and a reel cutting element comprising a helical cutting reel; the machine further comprising means for changing the speed of driven rotation of the cutting element from a first higher speed of rotation for a flail cutting element to a second lower speed of rotation for a reel cutting element.

As used herein, the term ground engaging means is intended to include within its meaning wheels, rollers and their equivalents.

Any feature in one aspect of the invention can be applied to other aspects of the invention, in any appropriate combination. In particular, method aspects can be applied to apparatus aspects, and vice versa. Furthermore, any, some and/or all features in one aspect can be applied to any, some and/or all features in any other aspect, in any appropriate combination.

It should also be appreciated that particular combinations of the various features described and defined in any aspects of the invention can be implemented and/or supplied and/or used independently.

### BRIEF DESCRIPTION OF THE DRAWINGS

These and other aspects of the present invention will become apparent from the following exemplary embodiments that are described with reference to the following figures.

FIG. 1 is a schematic diagram of a self-propelled cutting machine with cutting units arranged in accordance with various embodiments of the present disclosure.

FIG. 2 shows an example flail cutting unit, in accordance with various embodiments of the present disclosure.

FIG. 3 shows flail cutting units of FIG. 2 being mounted onto the self-propelled cutting machine of the kind shown in FIG. 1, in accordance with various embodiments of the present disclosure.

FIG. 4 shows a cutting unit attached to a frame by a magnetic connection, in accordance with various embodiments of the present disclosure.

FIG. 5 shows the cutting unit connection of FIG. 4 with the magnetic connection disconnected, in accordance with various embodiments of the present disclosure.

FIG. 6 shows a drive member face that faces a cutting unit in the embodiment of FIG. 4, in accordance with various embodiments of the present disclosure.

FIG. 7 shows a cutting unit head face that faces the drive member face of FIG. 6, in accordance with various embodiments of the present disclosure.

FIG. 8 shows a drive member face that faces away from a cutting unit head face in the embodiment of FIG. 4, in accordance with various embodiments of the present disclosure.

FIG. 9 shows a front view of the drive member of FIG. 4, in accordance with various embodiments of the present disclosure.

### DETAILED DESCRIPTION

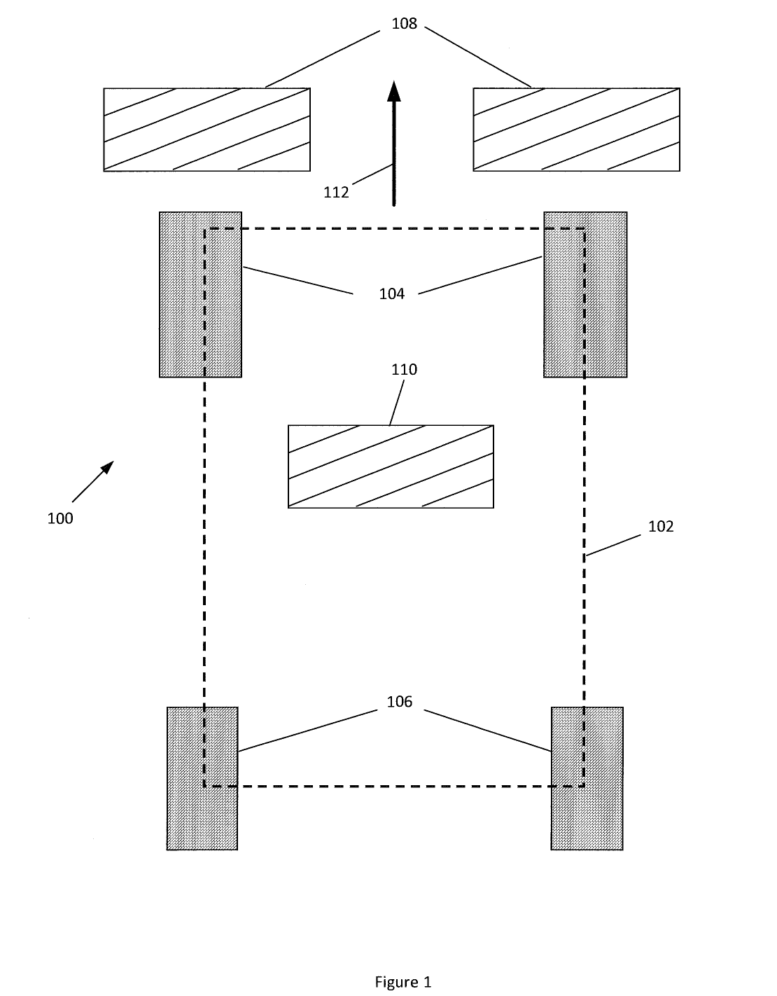

FIG. 1 shows a schematic diagram of self-propelled cutting machine configuration. The machine 100 comprises a chassis 102 connected to which are a pair of front wheels 104 and rear wheels 106. A pair of cutting units 108 are situated substantially in front of the two front wheels 104, with a third cutting unit 110 situated substantially between and in front of the two rear wheels 106. This arrangement has a number of advantages compared to other arrangements.

All three cutting units 108, 110 cut grass that has not been flattened by wheels passing over the vegetation beforehand. This means that the vegetation is easier to cut than if a similar arrangement were towed behind the machine for example. The front pair of cutting units 108 are connected to the chassis 100 in such a way as to allow them to be moved from a horizontal position (as shown in FIG. 1) to a position more vertical than horizontal. The width of the machine is thus limited by the width of the chassis rather than the width of the extent of the cutting units 108. Therefore, the machine 100 can pass through narrower openings than a machine with a single cutting unit of the same width for example. Furthermore, this second orientation means that the machine 100 can be driven over rough ground, over bumps or be generally transported without damaging the cutting units 108 by moving them into an upright orientation to avoid hitting the ground.

The third cutting unit 110 is supported beneath the chassis 102. It is orientated so as to cut the vegetation which passes in between the first pair of cutting units 108 as the machine 100 moves forward (indicated by arrow 112). The third cutting unit 110 slightly overlaps the first and second cutting units 108 to ensure that a single, continuous swathe of vegetation is cut.

Another advantage of the arrangement shown in FIG. 1 is that by using three separate cutting units 108, 110 as opposed to a single unit, greater flexibility in cutting is afforded. For example, a narrower swathe of vegetation can be cut by lifting, or depowering one of the front cutting units 108. This can be useful where damage to the cutting unit could occur, for example, cutting vegetation adjacent to a gravel path. Furthermore, maintenance of the machine 100 is simpler, e.g., if a cutting unit 108, 110 is damaged, it would be less expensive to replace or repair it compared to a large single cutting unit.

Although wheels 106, 108 are described, other ground engaging means can be used. For example, continuous (caterpillar) tracks can be preferable if the terrain is steep, or the ground is soft; although there would be a trade-off for speed and mechanical complexity choosing continuous tracks over wheels.

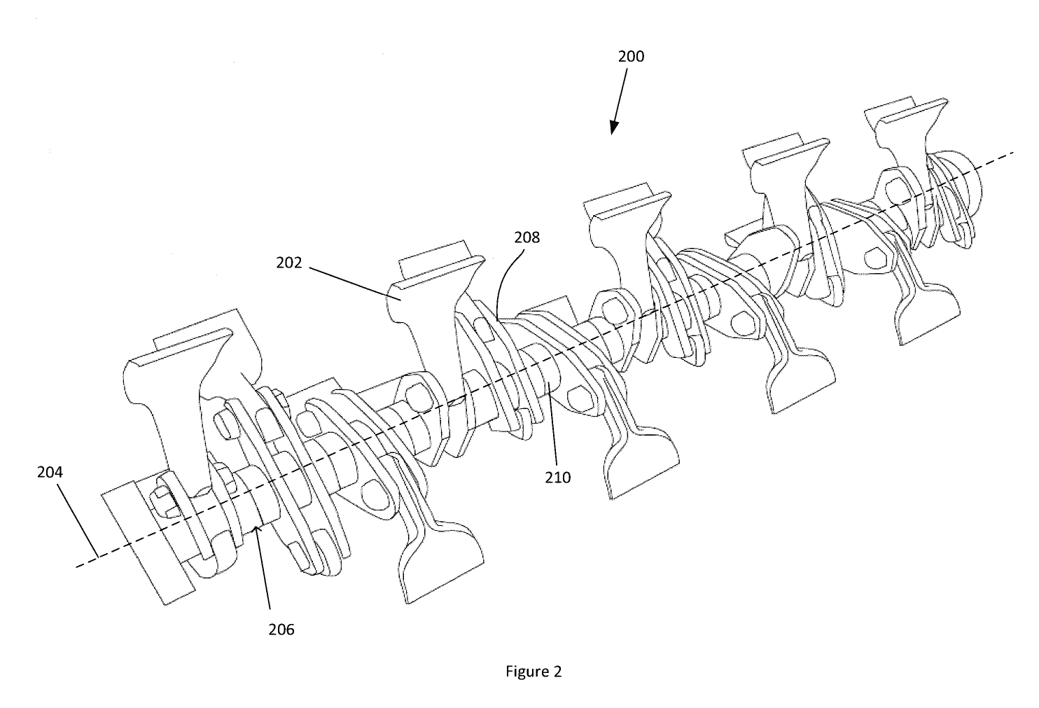

In place of the helical cutting reels that are commonly provided in machines having this configuration, cutting units 108, 110 are provided with cutting elements as shown for example in FIG. 2. In various embodiments, it is a feature that the cutting units 108, 110 can be provided with both cutting elements as shown in FIG. 2 and conventional reel cutting elements. Both cutting elements have the same dimensions and use the same fixing means so that they are interchangeable with one another. This feature is described in more detail below.

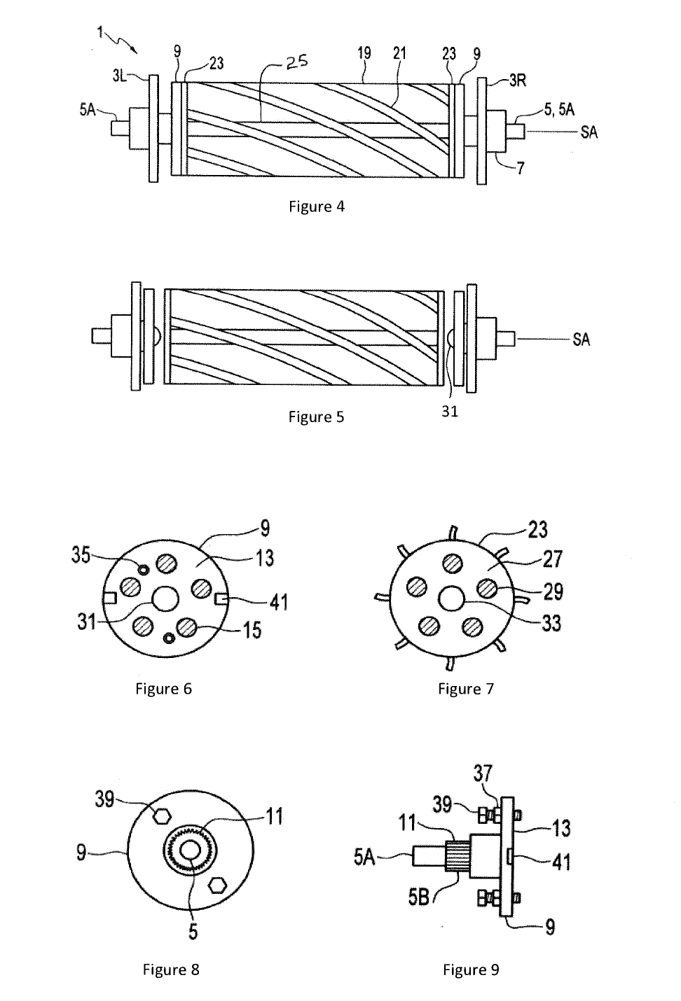

FIG. 2 shows an example of a flail cutting unit 200. Flail cutting unit 200 comprises a number of cutters 202 mounted on a shaft 206 for rotation about an axis 204. More specifically, pairs of flanges 208 are sandwiched between spacing collars 210, the flanges 208 being rigidly mounted for rotation as part of the shaft assembly. Each pair of flanges 208 supports a pair of opposed cutters 202, with each cutter 202 being free to rotate about a corresponding bolt 212 which extends between the flanges 208 of the pair. Each cutter 202 is therefore rotatable about an axis parallel to and spaced from the axis 204 of the shaft 206. Each pair of cutters 202 associated with the same flange 208 are spaced by 180°, and each cutter 202 is spaced by 60° to the cutter 202 on the neighbouring flange 208. Thus, the cutter 202 spaced three along is in the same orientation. This ensures that the unit 200 is balanced when in use. In use, the shaft 204 is rotated, swinging the cutters 202 into the vegetation. The distal edges of the cutting elements can be slightly sharpened to aid cutting the vegetation, but the high inertia of the cutting elements 202 hitting the vegetation will often suffice. Flail cutting element 200 is adapted to be fitted onto the self-propelled cutting machine 100 described in FIG. 100, within any of the three cutting units 108, 110. The fitting means is described in detail below and in relation to FIGS. 4 to 9.

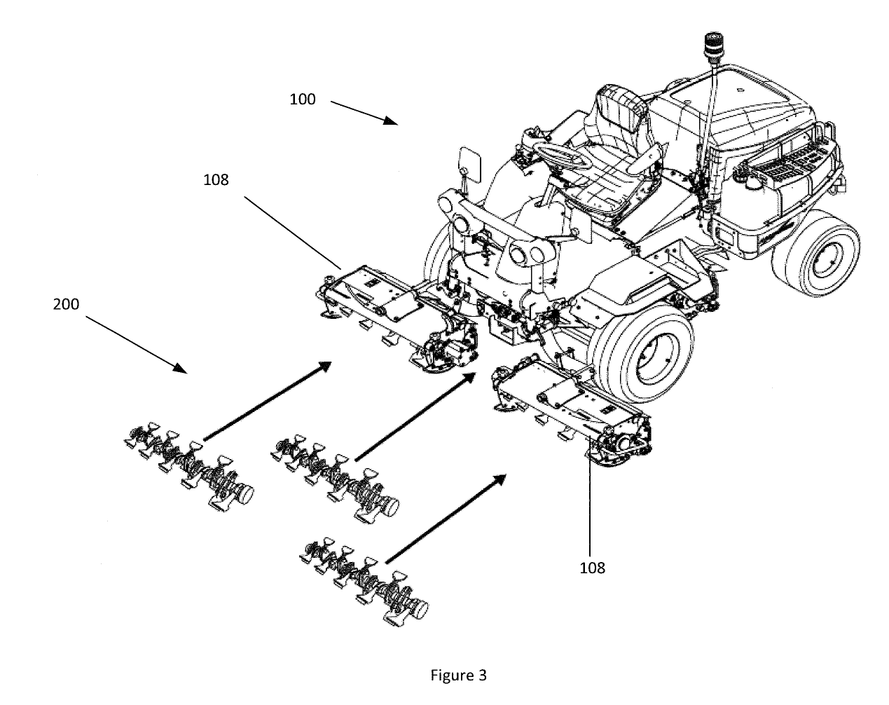

As described above, cutting units 108, 110 are adapted to receive interchangeable cutting elements. FIG. 3 illustrates three flail cutting units 200 being mounted onto the self-propelled cutting machine 100. In another arrangement reel cutting units can be mounted. In various embodiments, all three cutting units 108, 110 are of the same type.

The interchangeable feature is afforded in this example by a magnetic connection shown in FIGS. 4 to 9. FIG. 4 shows a cutting unit 19 (in this example, a reel cutter) with an associated assembly. A cutting unit assembly 1 comprises a frame with right and left side plates 3R, 3L, with shaft apertures therethrough. A bearing housing 7 is mounted over each shaft aperture through which a stub shaft 5 extends. This stub shaft 5 engages a bearing in the bearing housing 7 so that the stub shaft 5 and the bearing rotate together. An outer end of the stub shaft 5A is provided outside one of the side plates 3 and is adapted to be rotated about the shaft axis SA. In various embodiments, this is achieved by mounting a motor (not shown) on the side plate 3.

Drive member 9 can move along the shaft axis SA toward or away from bearing housing 7. FIG. 9 shows an inner end 5B of a stub shaft 5, located between right and left side plates 3R, 3L. In the example shown in FIG. 9, stub shaft 5 is splined so that the drive member 9 engages the splines to rotate with the stub shaft 5, yet can move along the shaft axis SA with respect to the stub shaft 5. Alternatively, the drive member 9 can be fixed with respect to the stub shaft 5, and both move with respect to the bearing housing 7. This movement allows for cutting unit 19 to be removed as described below.

FIG. 6 shows the drive face 13 of the drive member 9, which is perpendicular to shaft axis SA. A plurality of magnets 15 are mounted flush onto the drive face 13. FIG. 7 shows the corresponding view of the cutting unit head face 23, which also has magnets 29 mounted flush on it. These magnets 29 are at corresponding positions to those of the drive face 13 and are of opposite polarity. This increases the magnetic force between drive face 13 and cutting member head face 23, compared to using just one set of magnets.

In order to properly align the cutting unit 19 onto the shaft axis SA, and to maintain this alignment during operation, a centring bulb 31 is provided which extends outward from the face 13 and into a corresponding recess 33 in the cutting unit head face 23. The bulb 31 and recess 33 are symmetrical about the shaft axis SA so that the cutting unit 19 and stub shaft 5 can rotate with respect to one-another (when not magnetically engaged).

In use, the cutting unit 19 is put in place, then drive plates 9 are moved towards the cutting unit heads 23. After the centring bulb 31 recesses into the recess 33, the magnetic force between magnets 29 and 15 will act to rotate the cutting unit 19 into the correct orientation. The magnets 29, 15 then hold the cutting unit 19 in place with sufficient force as to allow transmission of power to drive the cutting unit 19.

A further advantage of this construction is that it effectively provides a slip-clutch. If the cutting unit 19 strikes an obstruction such as a rock, the magnetic force is overcome, allowing the cutting unit 19 to rotate with respect to the drive plate 9, thus not damaging the cutting unit 19. If this feature is not required, a pin or bolt can be placed through the drive plate 9 into the cutting unit head 23 to hold them rigidly together.

When replacing the cutting unit 19, a mechanism is required to break the magnetic attraction between magnets 15 and 29. FIGS. 6, 8 and 9 illustrate two of such mechanisms that can be used individually or together. Threaded apertures are provided in on of the faces 13, 37 (for example, by welding a nut 37 over a hole 37 in drive plate 9. A bolt 39 can then be screwed into this, and as it is screwed in, it pushes plates 9 and 23 apart, breaking the magnetic connection and allowing drive plate to be moved along the shaft axis SA away from the cutting unit 19. Alternatively or additionally, grooves 41 are provided at the edges of one or both plates 9, 23 into which a prying instrument can be inserted to pry drive plate 9 away from cutting unit head 23.

FIGS. 4 and 5 show an exemplary embodiment where magnetic coupling occurs at both ends of the cutting unit 19. An alternative is that the cutting unit is magnetically coupled only at one end, and is coupled by slotting onto a stub shaft 5 at the other.

For further details relating to a magnetic coupling device, reference is directed to WO 2007/038857.

Each cutting unit 108, 110 has a motor attached to it to rotate the cutting unit. Depending on the type of cutting unit used, the optimal speed of rotation can be different. For example, for optimal cutting, a reel cutter is rotated at 1000 rpm whilst a flail cutter is rotated at 2500 rpm. When a cutting unit 108, 110 is interchanged with another of a different type, the speed of rotation is preferably altered in order to rotate at the optimal speed. This can be achieved in a number of ways.

In one embodiment, the cutting units 108, 110 are driven by means of hydraulic motors and a hydraulic pump. A simple method for changing the rotation of the drive shaft is then to change the flow rate of the hydraulic pump. In the example given above, when using a flail cutter, the flow rate can be 3 to 5 and perhaps 2.5 times that when using a reel cutter.

Another method of changing the rotation of the drive shaft would be by using a gearbox. In various embodiments, each motor would have a gearbox which has at least two speed settings, a low speed when using a reel cutter and a higher speed when using a flail cutter. In the example given above, the gear ratio of the low speed setting to the high speed setting can be 2.5. This gearbox arrangement is of course applicable to both hydraulic and electric motors.

Alternatively, the gearbox can be situated between the hydraulic pump and the engine drive. This allows the engine drive to be run at a different speed to the hydraulic circuit and hence produce the necessary change in rotation speed.

In various other embodiments, instead of replacing the flail cutting element within a cutting unit by a reel cutting element (or vice versa), the entire cutting unit containing the flail cutting element can be replaced by a new cutting unit containing a reel cutting element (or vice versa). There will in such an arrangement be no need for a clutch within the cutting unit and a more robust mounting of the cutting element within the support can be achievable, at the expense of redundancy in the support components. In this arrangement, if a hydraulic motor is provided on each cutting unit, the necessary change in speed of rotation between flail cutting elements and reel cutting elements can be achieved with a hydraulic ratio controller at each cutting unit. In the this way, the same flow rate of hydraulic fluid from the central pump will produce different speeds of rotation in a cutting unit with a flail cutting element than in a cutting unit with a reel cutting element. If appropriate, a mechanical ratio controller could alternatively be employed.

Each feature disclosed in the description, and (where appropriate) the claims and drawings can be provided independently or in any appropriate combination.

Any reference numerals appearing in the claims are by way of illustration only and shall have no limiting effect on the scope of the claims.

1-19. (canceled)

20. A self-propelled cutting machine comprising:
a chassis;
two spaced forward ground engaging means having a common transverse axis;
at least one rearward ground engaging means;
a propulsion unit acting through at least one of the forward and rearward ground engaging means to propel the cutting machine over ground; and
at least three cutting units, each cutting unit comprising:
a support and a cutting element drivably rotatable within the support about a cutting element axis that is horizontal in cutting use, there being one of the cutting units positioned in use in front of each forward ground engaging means and one of the cutting units positioned in use behind the common transverse axis of the forward ground engaging means so that the three cutting units cut a single swathe; wherein each cutting element comprises:
a driven shaft extending along the cutting element axis and a plurality of flail elements spaced along the length of the driven shaft and each rotatable with respect to the cutting element axis about a flail element axis that is parallel to and spaced from the cutting element axis.

21. The cutting machine according to claim 20, wherein each cutting unit positioned in use in front of each forward ground engaging means is mounted on the chassis so as to be liftable into a transport position in which the cutting element axis is closer to vertical than horizontal.

22. The cutting machine according to claim 20, wherein each cutting unit comprises a motor mounted on the support for rotating the cutting element.

23. The cutting machine according to claim 22, wherein each cutting unit comprises a clutch providing driving engagement between the motor and the driven shaft, the driven shaft being removable from the cutting unit support.

24. The cutting machine according to claim 23, wherein the clutch comprises a magnetic clutch.

25. The cutting machine according to claim 23, further comprising for each cutting unit a replacement cutting element comprising a helical cutting reel, the replacement cutting element being mountable in the support for driven rotation by the motor through the clutch.

26. The cutting machine according to claim 20, further comprising for each cutting unit a respective interchangeable helical cutting unit comprising a support and a cutting element drivably rotatable within the support about a cutting element axis that is horizontal in cutting use, wherein each cutting element comprises a helical cutting reel extending along the cutting element axis.

27. The cutting machine according to claim 25, further comprising a means for changing the speed of driven rotation of the cutting element from a first higher speed of rotation for a cutting element comprising flail elements to a second lower speed of rotation for a cutting element comprising a helical cutting reel.)

28. The cutting machine according to claim 27, wherein the means for changing the speed of driven rotation comprises a gear box at each motor.

29. The cutting machine according to claim 27, wherein each motor is a hydraulic motor and the means for changing the speed of driven rotation comprises a control for varying a fluid output of a pump supplying each hydraulic motor.

30. The cutting machine according to claim 27, wherein each motor is a hydraulic motor and the means for changing the speed of driven rotation comprises a ratio controller at each hydraulic motor.

31. An adaptable self-propelled cutting machine comprising:
a chassis;
two spaced forward ground engaging means;
at least one rearward ground engaging means;
a propulsion unit acting through at least one of the forward and rearward ground engaging means to propel the cutting machine over ground;
at least three cutting unit stations, there being at each cutting unit station a cutting unit comprising a support and a cutting element drivably rotatable within the support about a cutting element axis that is horizontal in cutting use, there being one cutting unit station positioned in use in front of each forward ground engaging means and one cutting unit station positioned so that the three cutting units cut a single swathe; wherein each cutting unit station is provided with at least two different cutting elements that are mountable in the support of the cutting unit, wherein the at least two different cutting elements comprise:
a flail cutting element comprising a driven shaft extending along the cutting element axis and a plurality of flail elements spaced along the length of the driven shaft and each rotatable with respect to the cutting element axis about a flail element axis that is parallel to and spaced from the axis; and
a reel cutting element comprising a helical cutting reel, and
a means for changing the speed of driven rotation of the cutting element from a first higher speed of rotation for the flail cutting element to a second lower speed of rotation for the reel cutting element.

32. The cutting machine according to claim 31, wherein each cutting unit station comprises a single cutting unit provided with at least two different cutting elements that are alternatively mountable in the support of the cutting unit.

33. The cutting machine according to claim 31, wherein each cutting unit positioned in use in front of each forward ground engaging means is mounted on the chassis so as to be liftable into a transport position in which the cutting element axis is closer to vertical than horizontal.

34. The cutting machine according to claim 31, wherein each cutting unit comprises a motor mounted on the support for rotating the cutting element.

35. The cutting machine according to claim 34, wherein each cutting unit comprises a magnetic clutch providing driving engagement between the motor and the cutting element.

36. The cutting machine according to claim 31, wherein the means for changing the speed of driven rotation comprises a gear box at each motor.

37. The cutting machine according to claim 31, wherein each motor is a hydraulic motor and the means for changing the speed of driven rotation comprises a control for varying a fluid output of a pump supplying each hydraulic motor.

38. The cutting machine according to claim 31, wherein each motor is a hydraulic motor and the means for changing the speed of driven rotation comprises a ratio controller at each hydraulic motor.

39. The cutting machine according to claim 31, wherein each motor is a hydraulic motor and the means for changing the speed of driven rotation comprises a ratio controller at each hydraulic motor.
